(19) United States
(12) Patent Application Publication
(10) Pub. No.: US 2002/0072413 A1
(43) Pub. Date: Jun. 13, 2002

(54) Entertainment platform

(76) Inventors: Eduardo Arias, New York, NY (US); Isaac Arias, New York, NY (US); Ricardo Arias, New York, NY (US)

Correspondence Address: HALE AND DORR LLP, 300 PARK AVENUE, NEW YORK, NY, 10022, US

(21) Appl. No.: 09/860,186

(22) Filed: May 17, 2001

Related U.S. Application Data
(60) Provisional application No. 60/245,505, filed on Nov. 3, 2000.

(51) Int. Cl. G06F 17/00

(52) U.S. Cl. 463/42

(57) ABSTRACT

A method and apparatus of collecting and trading items provides for receiving collectible items on a file server, trading the items with other collectors and interacting with the items on the server. The items can typically be representative of trading cards including, for example, baseball cards, movie scenes, or in other instances, currencies. Various games can be built around the method including providing that the first player to collect all of the trading cards or Token instances will receive a reward. Multiple players can engage in the game using, for example, the Internet.

The present invention claims priority to Provisional Application Serial No. 60/245,505 filed Oct. 3, 2000 as provided for under 35 U.S.C. §119(e).

### TECHNICAL FIELD

This invention relates to an entertainment platform, and more particularly to an interactive entertainment platform suitable for play over a network, for example, the Internet.

### BACKGROUND

Collecting various items or collectibles has long been a recreational pastime, both as a hobby, in competition, or for other reasons. The diverse array of items that are collected includes toys, stamps, currency, and stickers; and they are often sought by collectors in order to enjoy their aesthetics. Baseball cards are an example of such items, and collectors often try to obtain complete sets of cards. These sets could be of all the players on a specific team, the particular collector's favorite players, the more popular players, or another grouping. Items that are relatively rare are also usually more valuable to collectors.

Obtaining desired collectible items can be accomplished in a variety of ways. Collectors can get them from their source, such as by buying packages containing random groupings of baseball cards. They can also barter with other collectors, often trading items from their own collection for items from other collectors'stock of collectibles. This invention relates to providing collectible items or tokens, and in particular, multimedia electronic items, and a method for trading items or tokens, using a computer system connecting to a plurality of collectors over a network, for example, the Internet.

### SUMMARY

The invention relates to a computer-network-based collection and trading system providing a unique and flexible methodology and structure for obtaining, trading and enjoying collectible items. The collectible items in this system are unique multimedia components that are stored on the system and are accessible to collectors over a network. Using a graphic interface, collectors can obtain new items and trade them with other collectors who are using the system, as well as access and enjoy their multimedia content. Rewards can also be associated with collecting individual or sets of items in the system to provide a greater incentive for collectors to use the system.

According to one embodiment of the present invention, collectors are registered to Zones and collect items belonging to the Zones by a variety of mechanisms including, but not by way of limitation, autodeposit, random, and/or a set of assignment rules. Further, collectors can collect items by trading with other collectors. Collectors can effect trades by, but not by way of limitation, searching the system for collectors who have collectible items for which they themselves are lacking; and/or search the system for collectible items owned by them but not by other collectors; and/or searching the system for a specific collector within a Zone. Once a trading partner is selected the collector can build an offer to the trading partner and include with the offer a text message. Collectors who receive offers can accept, reject or counter the offer. The collector who completes a Zone, obtaining all the collectible items, could receive a reward.

The details of embodiments of the invention are set forth in the accompanying drawings and the description below. Other features, objects, and advantages of the invention will be apparent from the description and drawings, and from the claims.

### DESCRIPTION OF DRAWINGS

FIG. 1 is an illustration of an electronic template for a collectible item;

FIG. 2 illustrates a system for collecting and trading collectible items;

FIG. 3 is a flowchart illustrating the flow for filling slots with collectible items;

FIG. 4 illustrates an embodiment of game flow for a system for collecting and trading collectible items;

FIG. 5 is a flowchart illustrating the dynamic creation of a Token instance;

FIG. 6 illustrates a view of a Zone through the SectionView;

FIG. 7 illustrates a view of a Zone through the ZoneView;

FIG. 8 illustrates a view of a Zone through the ListView;

FIG. 9 is a flowchart illustrating the selection of a trading partner;

FIG. 10 is a flowchart illustrating the dynamic of an offer to trade;

FIG. 11 is a flowchart illustrating how available trading partners are determined;

FIG. 12 is a flowchart illustrating how the common list between trading partners is determined;

FIG. 13 illustrates according to one embodiment of the invention, three ways players can trade collectible items with other players;

FIG. 14 illustrates a search report of collectors who own spare copies of or need a particular Token instance that is not owned by the searching player or that the searching player has spare copies of;

FIG. 15 illustrates the TokenMatch list; and

FIG. 16 illustrates the offer builder with message window.

Like reference numbers in the various drawings indicate like elements.

### DETAILED DESCRIPTION

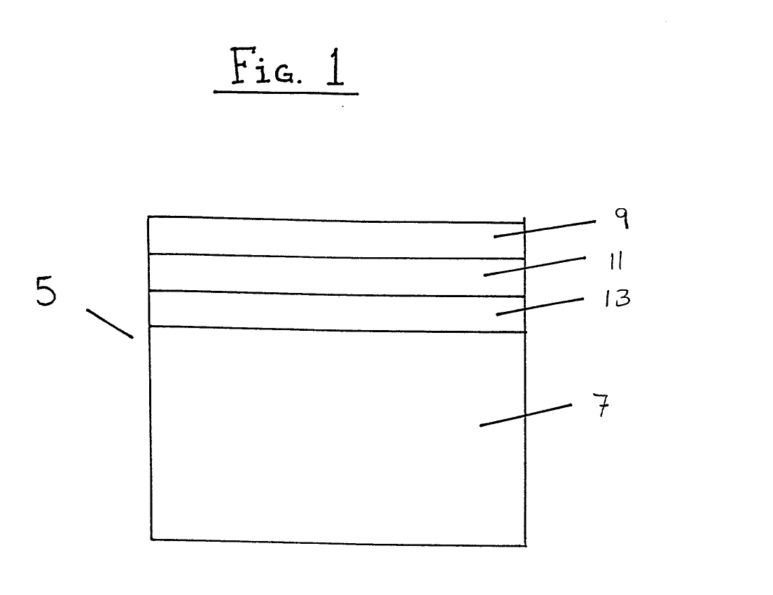

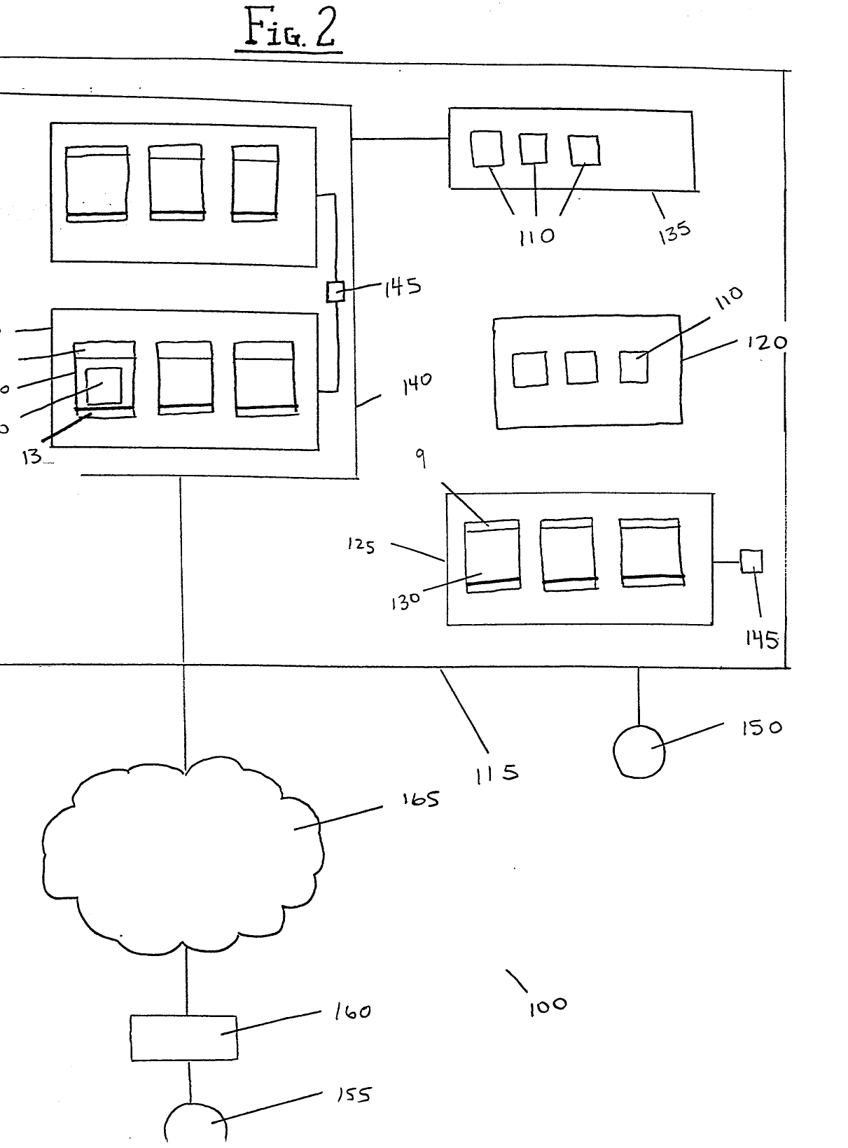

FIG. 1 illustrates an electronic template for a collectible item, designated a Token 5, which contains information 7. FIG. 2 illustrates a system 100 for collecting and trading Token instances 110. Token instances 110 are created from the template 5 and are stored on a file server 115. Each Token instance 110 is assigned a Token code 9; and instances 110 which contain the same information 7 have the same code 9, while different Tokens instances 110, having different information therein, have different codes 9. While multiple instances 110 of a Token code 9 can exist, each instance 110 of a Token preferably has a unique serial number 11. At any given time the number of instances of Tokens with a first Token code can be different than the number of instances of Tokens with a different Token code 9. Thus, some values of Token codes 9 can be relatively rare (and therefore harder to find and collect) because there are fewer instances of that code than the instances of another code value. All undistributed Token instances 110 are kept in a Token pool 120. In other embodiments of the invention, the total number of Token instances for a code value need not be set in advance to a predetermined number, but can be maintained as a percentage of the total number of Tokens being generated and available. Thus, a statistical approach can be used for distributing the Token instances as described in more detail below.

Referring to FIG. 2, to collect and enjoy the content of Token instances 110, a Player 155 communicates with the system server 115 over a computer 160 through a computer network 165, such as the Internet, to which the server 115 and the Player's computer 160 are connected. In one embodiment of the invention, the Player 155 receives one or more Tokens instances 110 from a Token pool 120 distributed by a mechanism determined by a system administrator 150 or an author of the Zone. These Token instances are placed in a player's private Token inventory pool 135, which is also located on the server 115. Token instances 110 thus “owned” by a Player 155 are preferably placed in the Player's Zone container slots 130 provided the Token instances match a specified criteria. Zones 125, as well as Token instances 110, can have attributes 13 that can determine how the information 7 contained in the Token instance 110 or Zone 125 is displayed. Token instances 110 of the same code 9 can, in different embodiments of the invention, have different attributes 13. Alternatively, if the Token instances do not match a specified criteria they remain in the player's Token inventory pool 135 until the correct Zone 125 and slot 130 are found. Reciprocally, at any given point in time, a Token instance 110 can be owned by only one Player 155, although that Player 155 can change, if ownership of the Token instance changes, for example through trading of the Tokens. A player 155 can be a member of multiple Zones 140 that reside on the server system 115. Rewards 145 can be associated with the completion of each Zone 125 or series of Zones 140. According to one embodiment of the present invention, rewards 145 can be in the form of granting access to a Zone 125 a player 155 is not currently a member or some type of tangible reward such as airline tickets or a personal digital assistant. A system administrator 150 (or Zone author) oversees the operation of the server, and can create one or more Zones 125 and Token instances 110, and will distribute the rewards 145 if any, associated with their collection.

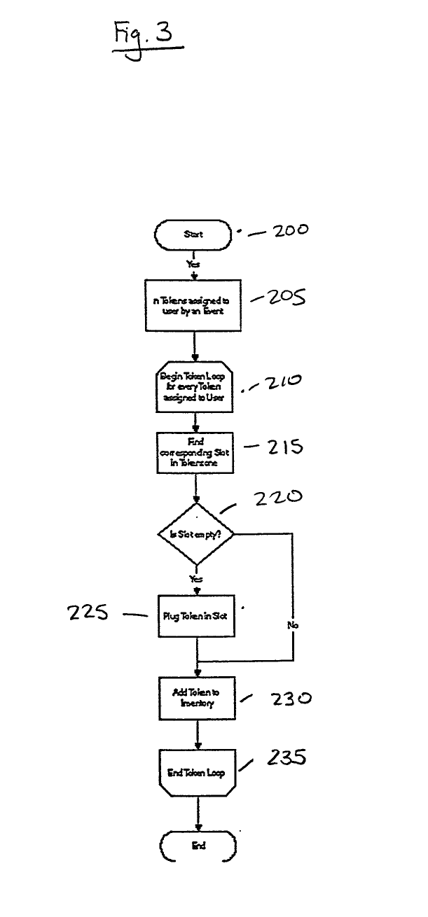

Token instances 110 can be collected in one or more Zones 125, defined on the server 115. Each Zone 125 consists of an exact number of unique Token “container slots” 130. The Token instances collected by players are stored in a player's private Token inventory pool 135. When a player explores a Zone 125 for which he/she is registered 140, the Tokens in the player's private Token inventory pool 135 that match slots 130 in that particular Zone 125 are automatically plugged into their corresponding slots 130. In one preferred embodiment of the present invention, but not limited by, each Token instance 110 has associated with it its own code 9 that can only be plugged into the Token slot 130 within a Zone that has the corresponding or compliment code 9. A Zone is considered complete when all the Zone slots are occupied with their corresponding Token instance 110. FIG. 3 illustrates how one embodiment of the present invention plugs Token instances into their corresponding slots within a Zone.

According to FIG. 3 a player logs onto the Zone for which he/she is a registered member 200 and based on the Token distribution mechanism(s) selected by the system administration and/or the Zone Author, the player is assigned 205 Token instances. The system then searches 210 through each Token in the player's Token inventory to see if the associated Token code matches a slot 215 in the Zone. Every slot has associated with it a code that corresponds to a Token code. If the slot is empty 220 and the codes match, the Token is plugged into the slot 225. However, if the slot is already occupied, the Token belongs to another Zone, or the corresponding Token code does not match, the Token is returned 230 to the player's Token inventory pool. This process is continued until every Token in the Token inventory pool is checked against all slots in a particular Zone 235.

One possible goal for Players 155 using the system 100 is to complete all Zones 125, by plugging Tokens in all of its slots 130, before other Players 155 do so, and thereby be entitled to a Reward 145. Another possible objective is to get Token instances 110 and thereby, be entitled to the information contained in them, which can be a form of electronic multimedia. Only Players 155 who “own” a Token instance 110 are entitled to access its information content 7.

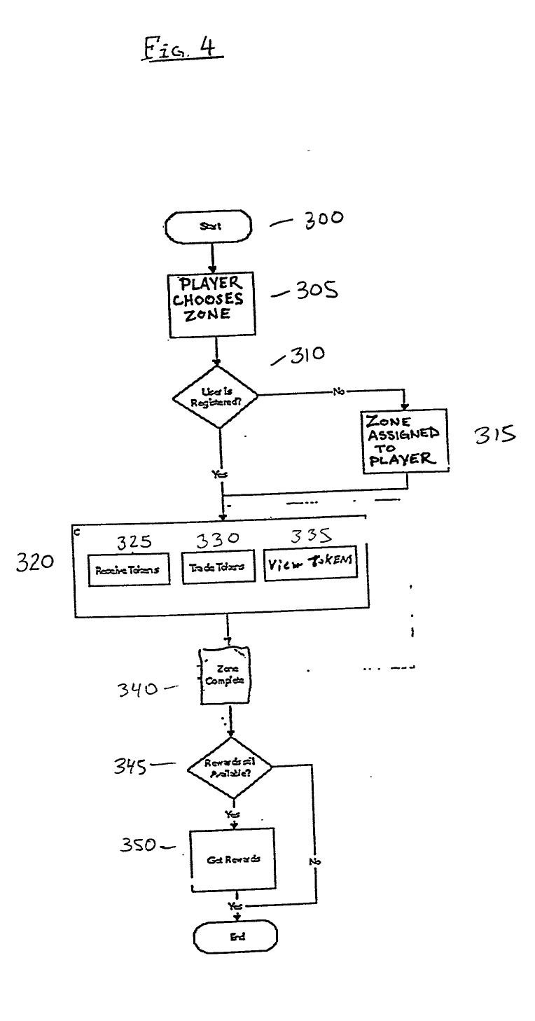

A game flow, in accordance with one embodiment of the invention, for the system 100 is illustrated in FIG. 4. First, a Player 155 logs into 300 the system 100 and chooses, at 305, a Zone or collection of Zones. One collection may relate to foreign currencies and another collection may relate to baseball or football players. The server 115 determines, at 310, if the Player 155 has previously been assigned a copy of the selected Zone collection and if not assigns, at 315, a new copy of that Zone collection to the Player 155. A Player 155 can find Zones collections of interest from the server 115 or from another location on the network 165, such as a Web site. All of a Player's Zones 125 are stored in the Player's Zone Inventory 140. Once a Player 155 has been assigned a collection of Zones 315, he or she begins to collect Tokens instances 110, at 320. This step includes receiving, at 325, and trading, at 330, Token instances, and viewing, at 335 the Player's Token instances, typically in collections of Zones. Once a Player 155 completes a Zone 125 at 340, the server 110 can determine, at 345, if the Player is entitled to a Reward 145. If yes, the server 110, at 350, bestow that reward 145.

Players can receive 325 new Token instances through a variety of mechanisms determined by the system administrator and/or the author of a Zone. Further, more than one distribution method can be assigned to the same Zone. In general, there are two broad classes of distribution mechanisms, one class controls the amount of Token instances distributed and the second class controls when Token instances are distributed. In one embodiment of the present invention, the distribution mechanism is a hybrid of both classes.

Potential methods of distribution in the first class include, but are not limited to, Random method, Deterministic method, and/or Hybrid method. In one embodiment of the Random method, players receive a fixed number of Tokens (as determined by the system administrator and/or the Zone author) taken randomly from the Zone's Token pool. In one embodiment of the Deterministic method, players are assigned one or more specific Token instances based on an assignment rule. Assignment rules can be based on a player's activity inside or outside of the Zone in question. Thus, in one embodiment of the Deterministic method, Token instances are assigned to a player based on following a hyperlink, activating a promotional code or completing a form. The Hybrid method assigns players Token instances based on a combination of assignment methods. In one embodiment of the Hybrid method, players have a certain number (x) of Token instances assigned to them using a Random method and another number (y) of Token instances assigned to them using a Deterministic method, resulting in a total distribution (z).

Scheduling methods in the second class include, but are not limited to, fixed time interval distribution and dynamically set intervals based on specified activities of a player as determined by the system administrator or the Author of the Zone. Further, more than one scheduling method can be assigned to the same Zone. In one embodiment of the scheduling method, a set of Tokens are assigned to a player using any method, such as Deterministic, each time the player logs into the system within a specified period of time (i.e., the player receives five Token instances in every twenty-four hour period). If the player fails to log into the system in the specified period of time, the player loses the opportunity to receive the scheduled distribution. In another embodiment of the scheduling method, a set of Token instances is assigned in a periodic manner. This embodiment distributes a fixed number of Token instances every time a player executes an activity (as defined by the system administrator or Zone author) during a set period of time. In this embodiment of the scheduling method, the player retrieves all the Token instances that were assigned since the last logon. In yet another embodiment of a scheduling method, a fixed number of Token instances are assigned to a player immediately after the performance of an activity, i.e. Deterministic method. Under this scheduling method players receive a certain number of Token instances for performing select activities, such a completing a form or clicking through a hyperlink.

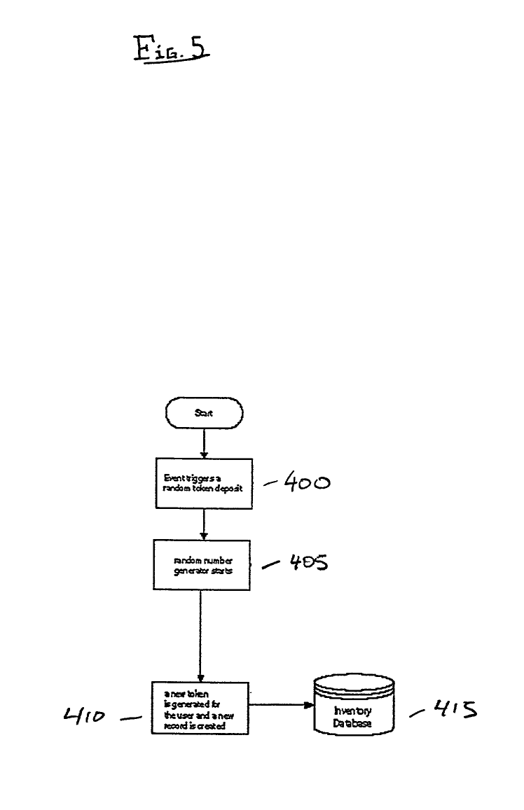

FIG. 5 illustrates one embodiment of the present invention that combines a Random method with a Deterministic scheduling method to determine what Token instances to assign and when to assign them. A player in a Zone performs some type of activity 400 specified by the Zone author or system administrator and as a result, triggers a distribution to the player. Which Token instances are assigned is determined by the Token instances'probability of appearing and a random number generator 405, taking the form of a multiple discrete distribution function. The Token instances to be assigned are determined and assigned to the player and a new record detailing the player's holding is created 410 and stored on an inventory database 415.

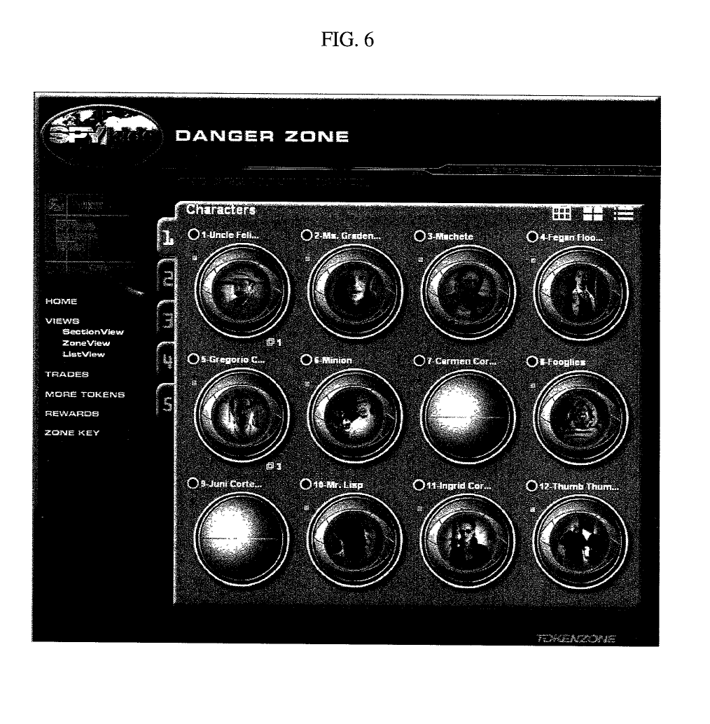

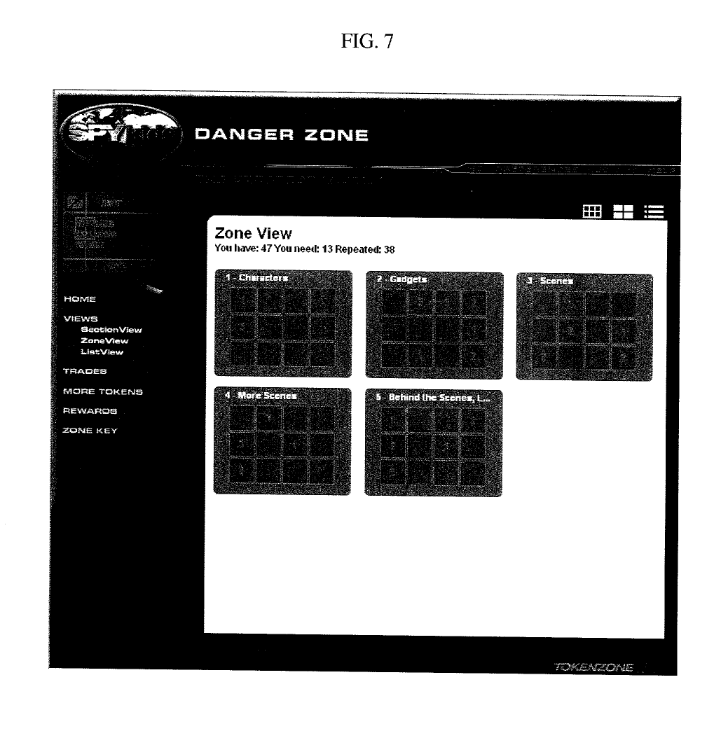

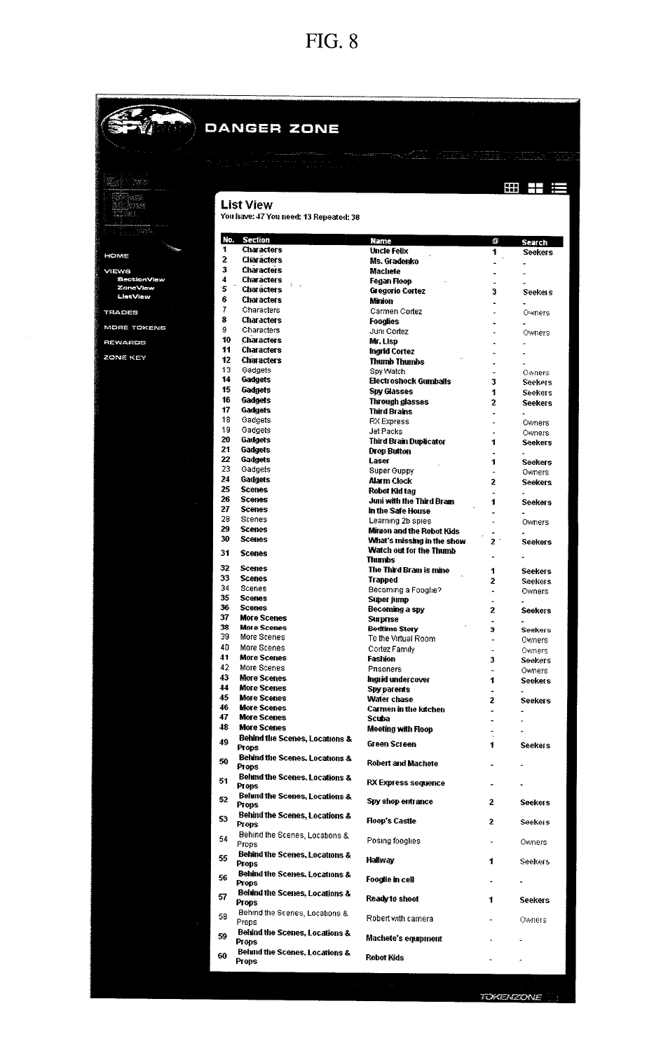

In other embodiments of the invention, a limited number of Token instances 110 are initially created and stored (at least virtually) in the Token pool 120. When a Player receives one of these instances 110, it is moved from the pool 120 to that Player's Token Inventory 135. In other implementations of the invention, the Token instance 110 can be created dynamically by the server 115 in the Player's Token Inventory 135, such as illustrated in FIG. 5. Once a Player 155 receives a Token instance 110, he or she is free to trade or exchange it (step 330) with other Players 155. A display of a Player's Zone(s), preferably automatically, also displays each Token instance and an indication of the number of Token instances either through a “SectionView” as illustrated in FIG. 6, a “ZoneView” as illustrated in FIG. 7, or a “ListView” as illustrated in FIG. 8.

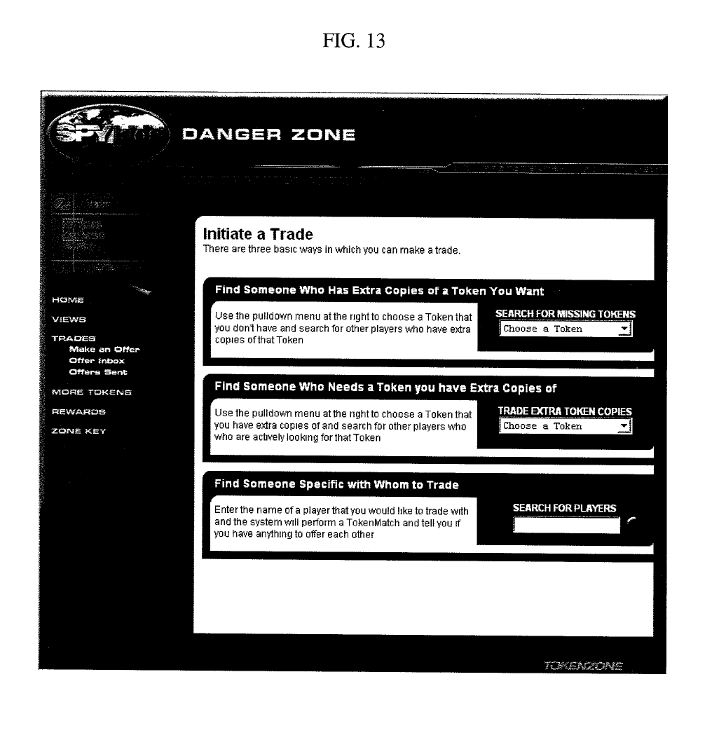

Players can also obtain Token instances by trading with other players on the system. According to one embodiment of the present invention, but not by way of limitation, Players can trade Token instances in at least three ways all of which are shown in FIG. 13. According to FIG. 13, Players can search the system for other collectors who have extra copies of a Token instance a player wants, or Players can search the system for other collectors who need Token instances of Token instances a player has extra copies of, or a Player may search the system for a specific collector to trade with.

The present invention provides a method and a system for placing a barter offer to trade assets between players. In one embodiment of the present invention, but not by way of limitation, a query is placed by a requester (Player A) at a client system (computer) and received by a server system. The server system receives requester's (Player A's) information, including identification of the requester (Player A) and the requested information, such as, the identification of the player or players sought as potential trade partners by the requester (Player A). The server system then searches the assets registered to each player and determines the commonalties and differences between the requester's set of assets (set A) and the requested set of assets (set B). The server system sends to the client system an electronic document describing the assets contained in set A that are not contained in set B, as well as the assets contained in set B that are not contained in set A. From the client system, Player A selects from set A and set B. Player A's selection from both sets represents the assets that the requester (Player A) is willing to offer in exchange for receiving the selected assets in set B. A request is placed by the client system to create a barter offer from the requester (Player A) to the requested (Player B). The server system receives the barter offer specification and creates a persistent record for the offer. Player B is, upon log in or other contact with the system, then presented with an electronic document describing the barter offer previously built by the requester (Player A). Player B can then accept, reject or counter offer Player A's offer. If Player B accepts, the server system receives the acceptance request and exchanges the assets specified in the offer between the requester (Player A) and the requested (Player B). The selected assets from set A are moved to set B and the selected assets from set B are moved to set A.

According to the same embodiment of the present invention, Player A can build multiple barter offers with multiple players, all of which can be concurrently outstanding.

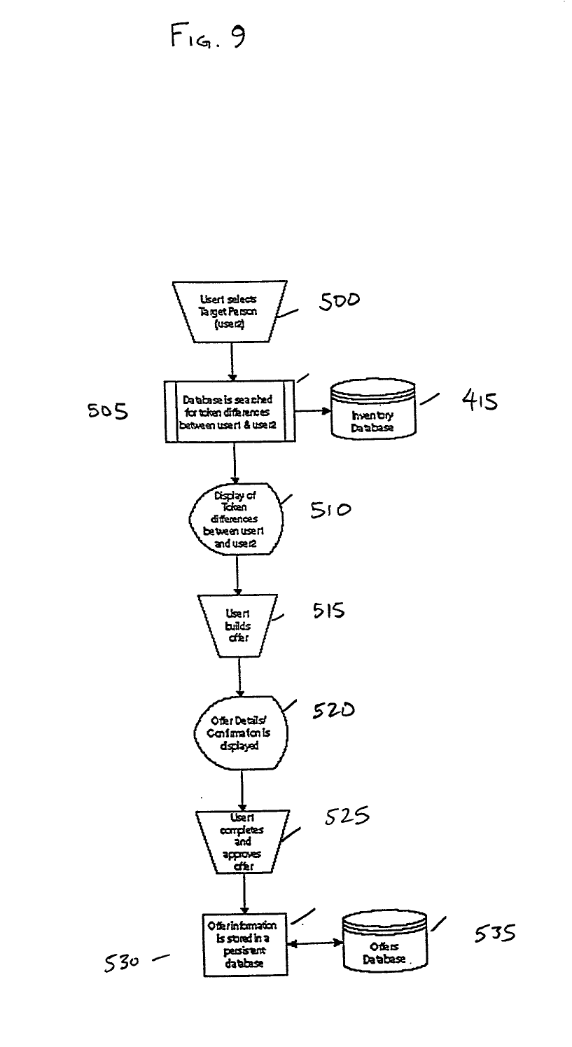

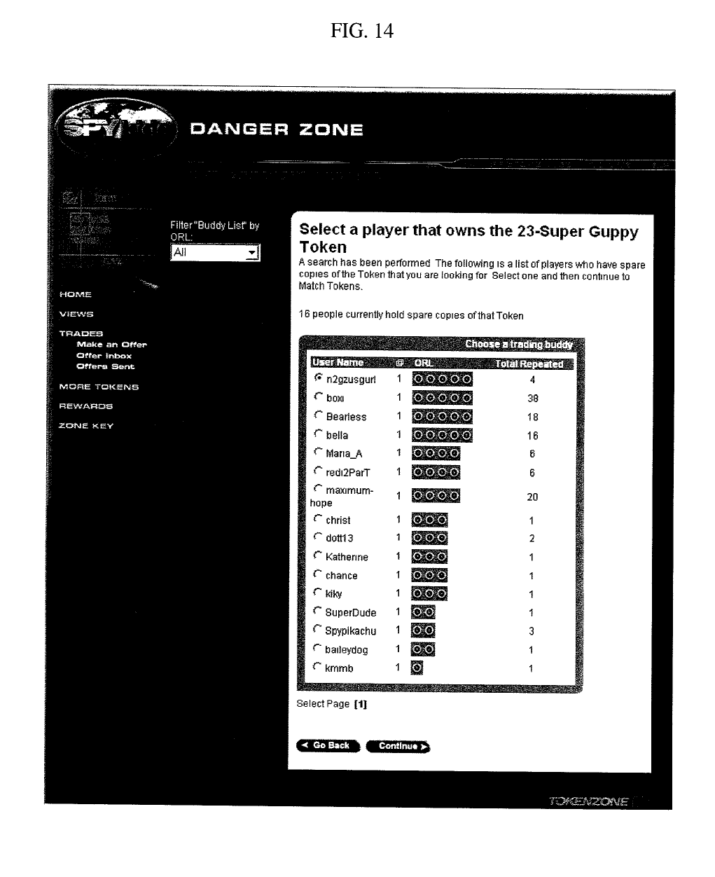

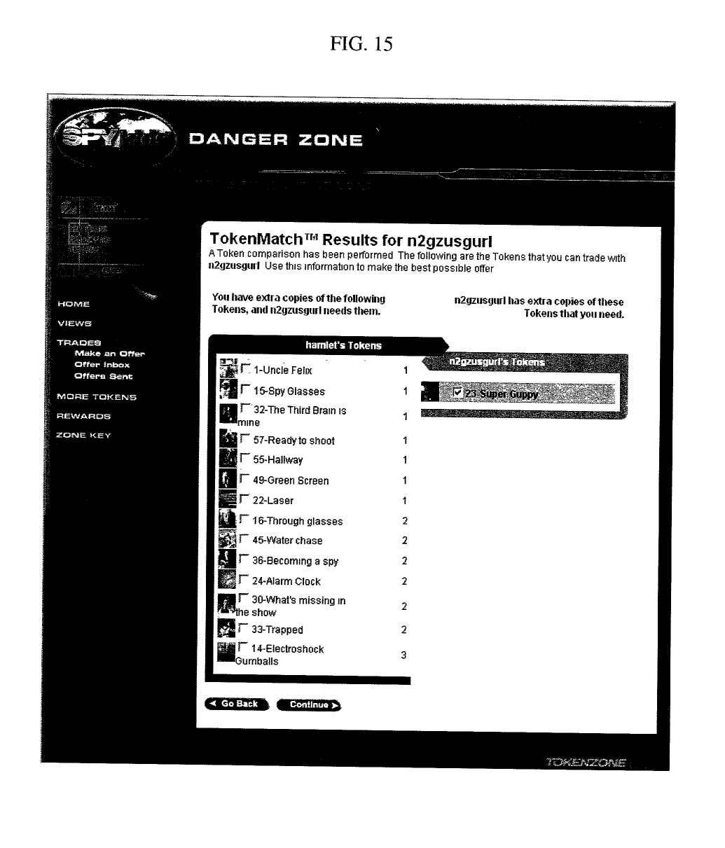

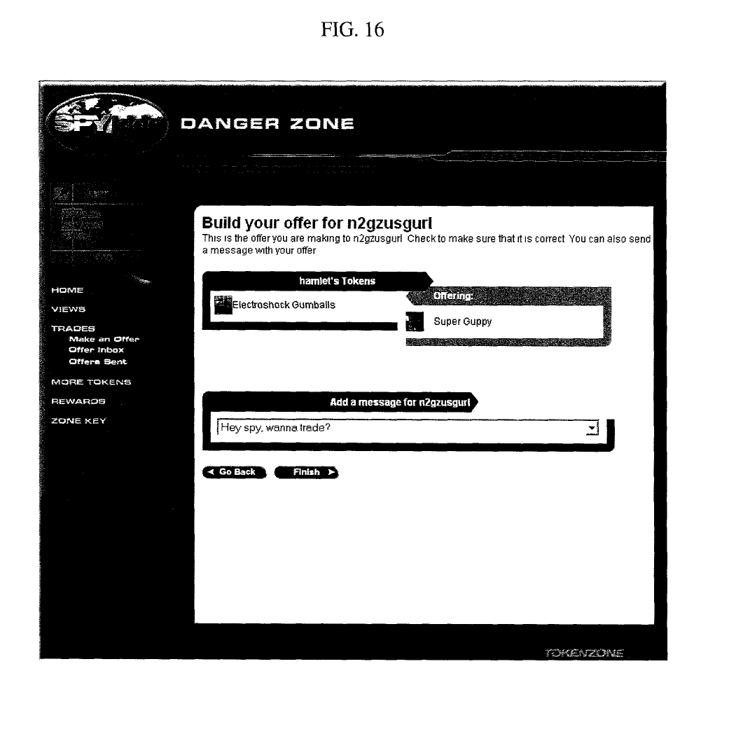

According to one embodiment of the present invention, as illustrated in FIG. 9, Player A selects a potential Trade Partner B 500 from a list of players in a Zone, or across several Zones, to propose a trade offer. FIG. 14, according to one embodiment of the present invention, illustrates an example of the type of list that is generated showing potential Trade Partners. The inventory database 415 is searched for differences 505 in Token instances between Player A and proposed Trade Partner B. The system displays 510 a list of Token instance differences between Player A and potential Trade Partner B. The list shows all the Token instances Trade Partner B has that Player A might be interested in and all the Token instances Player A has that Trade Partner B might be interested in. FIG. 15 according to one embodiment of the present invention illustrates a Token instance comparison between Player A and Player B, where Player A is shown what Token instances Player B does not own and therefore facilitate a trade. Player A builds an offer 515 by selecting from the list of Token instances owned by Trade Partner B and additionally selects the Token instances owned by A to offer B. Player A is then presented with an opportunity to review his/her selections 520 and the option of adding personalized information to the offer, i.e., a text message outlining why the trade would be good for both players. FIG. 16 illustrates the offer build with the accompanying message window, which operates much like e-mail. Player A then accepts the form 525 of his/her offer. The offer information is then stored 530 in a database 535.

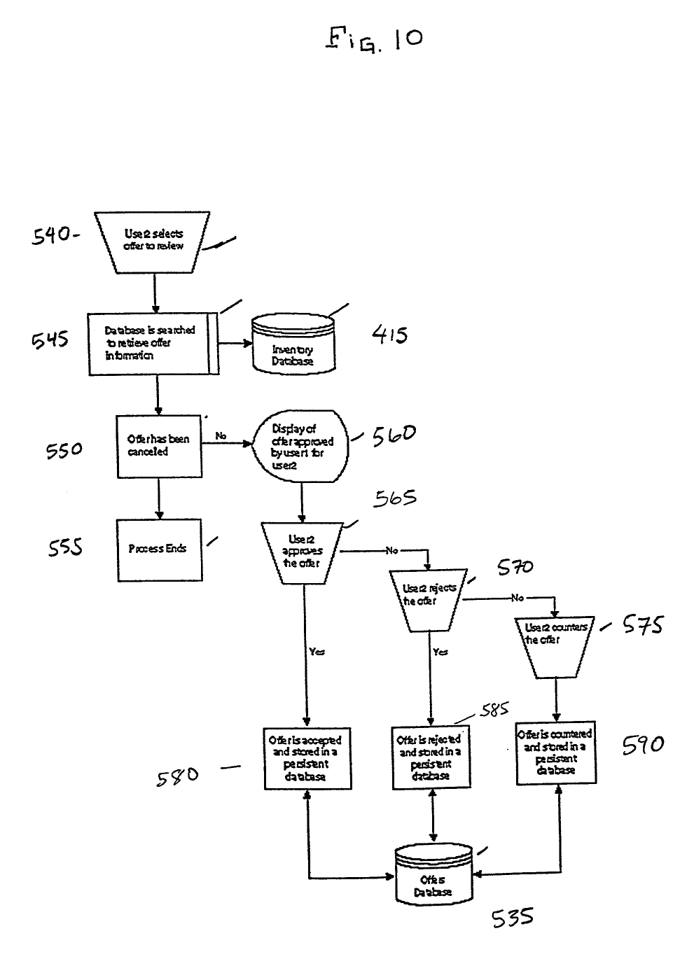

FIG. 10 illustrates one embodiment of Trade Partner B's options upon receipt of an offer. Potential Trade Partner B, once logged onto the system, has trade offers waiting for him/her to review and approve, reject or counter offer. B selects an offer to review 540. The selected offer is retrieved 545 from a database 415. The database checks to see whether or not the offer has been canceled 550 by Player A. If Player A has canceled the offer, the process ends 555 with respect to that potential trading partner. However, if the offer is still pending, the offer is displayed 560. B now has the option to accept 565, reject 570 or counter offer 575. Upon acceptance of the offer 565, the server system then exchanges the assets specified in the offer between Player A and Player B. The trade is recorded and stored 580 in the database 535. If B rejects A's offer 570, that action too is recorded and stored 585 in the database 535. If B counter offers A 575, the action is recorded and stored 590 in the database 535 and the process begins again, but now from Player A's perspective.

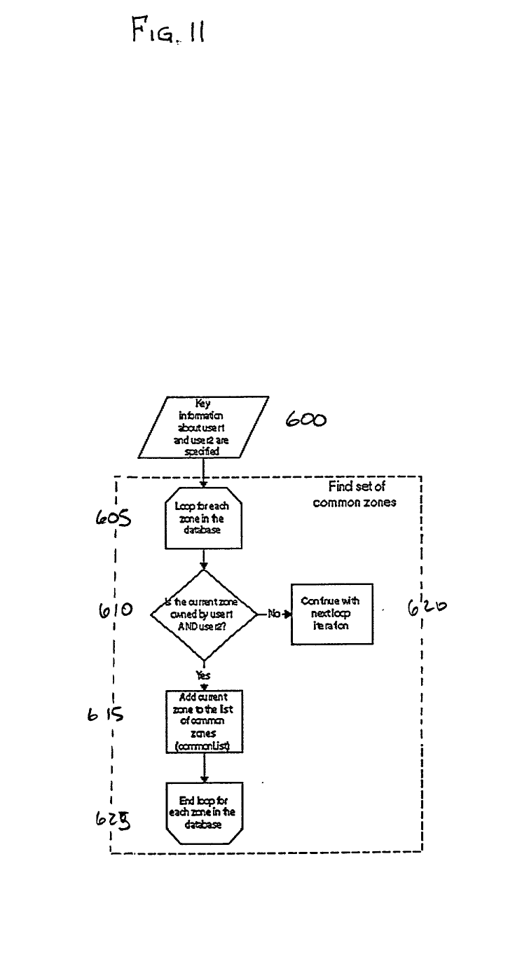

FIG. 11 illustrates how one embodiment of the present invention searches for potential trade partners. To find potential trade partners the system first takes key information about Player A and potential Trade Partner B 600 and searches through each Zone in the database 605 to find common Zones where both A and B are members or owners. For Zones where A and B are both members 610 the system adds this information to a common Zone list 615 and continues on to the next Zone in the database. If both A and B are not common members of a Zone, the process continues onto the next Zone 620 in the database. The system continues with this process until all Zones on the database are searched 625. This process generates four Token lists: Tokens own by A, but not by B; Token owned by B, but not by A; Tokens owned by both A and B, and; Tokens owned by neither A and B. The above lists can be on a per Zone basis or on a global common Zone basis.

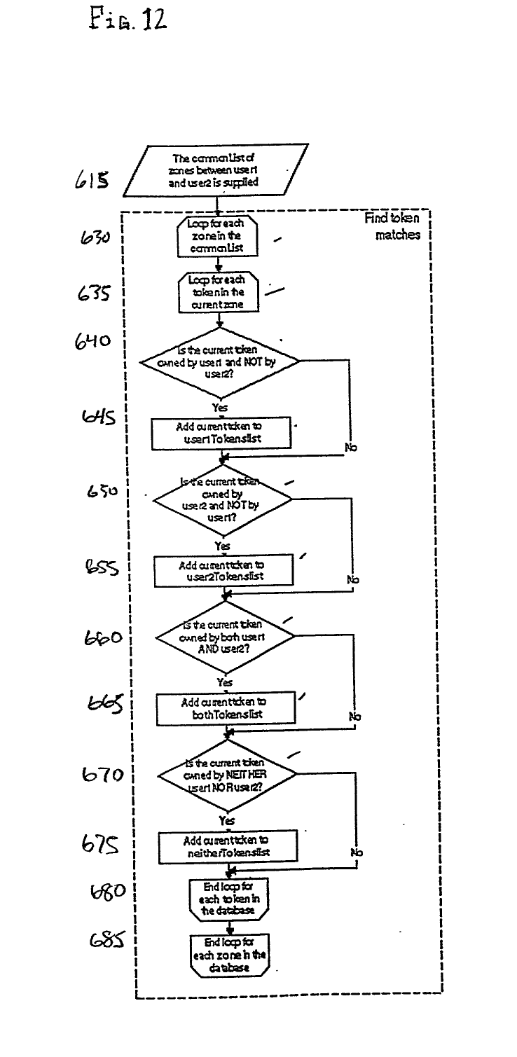

FIG. 12 illustrates how, according to one embodiment of the present invention the Token lists are updated. Starting from the common Zone list 615, the system searches through each Zone on the common list 630 checking each Token in each Zone 635 to determine whether a specific Token is owned by both A and B. The system first checks to determine if the current Token is owned by A, but not by B 640. If the answer is yes, this Token is added to A's Token list 645. Next, the system determines whether the current Token is owned by B, but not by A 650. If the answer to this question is yes, this Token is added to B's Token list 655. The system then checks to see whether the current Token is owned by both A and B 660. If the answer is yes, the Token is added to the owned by both A and B list 665. Lastly, the system determines whether the current Token is owned by neither A or B 670. If yes, the system adds this Token to the owned by neither A or B Token list 675. The system performs this operation for each Zone on the common Zone list 680 and each Token in each of the common Zones 685. The lists are then stored on a database and presented to the player requesting a listing of potential trade partners. The requesting player can then select his/her most desirable trading partner or partners.

Additions, deletions and other modifications of the described embodiments are within the skill of those practiced in this field and are within the scope of the following claims.

What is claimed is:

1. A method for collecting items comprising:
receiving collectible items on a system;
trading the items with other collectors; and
interacting with the items on the system.

2. The method of claim 1 wherein the system is a file server.

3. The method of claim 2 wherein the collectible items include electronic information.

4. The method of claim 3 wherein the collectible items include:
a Token code;
a unique serial number; and
an attribute that determines how the information will be displayed.

5. The method of claim 3 wherein the collectible items are Token instances.

6. The method of claim 2 including communicating with the file server over a network.

7. The method of claim 6 wherein the network is the Internet.

8. The method of claim 2 wherein collectible items are assigned to Zones.

9. The method of claim 8 wherein a collector can only collect and trade collectible items for Zones assigned to the collector.

10. The method of claim 2 wherein trading with other collectors comprises:
obtaining information from the server about what items the other collectors have and lack;
offering to trade items with other collectors; and
enabling the other collectors to accept, reject or counter the offer.

11. The method of claim 2 wherein a collector who collects a complete set of collectible items receives a reward.

12. The method of claim 11 wherein the first collector to collect a complete set of collectible items is declared the winner of the game.

13. The method of claim 2 further comprising distributing the collectible items based on a random method.

14. The method of claim 2 further comprising distributing the collectible items based on a set of assignment rules.

15. The method of claim 14 wherein the set of assignment rules is an automatic deposit method applied on a time interval schedule.

16. The method of claim 2 further comprising distributing the collectible items based on a combination of a random method and a set of assignment rules.

17. A system for collecting items comprising:
a file server;
collectible items stored on the server; and
a network connection allowing players to interact with the collectible items.

18. The system of claim 17 wherein the collectible items comprise electronic information.

19. The system of claim 17 wherein the network is the Internet.

20. The system of claim 17 further comprising
communications components whereby players can trade collectible items with each other.

21. The system of claim 20 further comprising
elements for enabling players to obtain listings of what items other players have and need to facilitate trading.

22. The system of claim 21 wherein players trade collectible items with each other by building an offer of collectible items to exchange.

23. The system of claim 21 wherein obtaining listings of what items other players have and need comprises
searching through each Zone in common between collectors;
determining whether or not a collectible item in a common Zone is owned by both collectors; and
displaying the collectible items not commonly owned by both collectors.

24. The system of claim 17 further comprising elements whereby players can make, accept, reject and counter offers to trade items with other players.

25. The system of claim 17 wherein collectible items are distributed based on a random method.

26. The system of claim 17 further comprising elements for distributing collectible items based on a set of assignment rules.

27. The system of claim 26 wherein the set of assignment rules is an automatic deposit method applied on a time interval schedule.

28. The system of claim 17 further comprising elements for distributing collectible items based on a combination of a random method and a set of assignment rules.

29. An article comprising a computer-readable medium that stores computer-executable instructions for causing a computer system to:
create and store collectible items on a system; and
allow collectors to obtain, trade and interact with the items stored on the system.

30. The article of claim 29 wherein the collectors interact with the server through a network connection.

31. An apparatus for collecting items comprising:
means for receiving collectible items on a file server;
means for trading items with other collectors; and
means for interacting with the items on the server.

32. The apparatus of claim 31 wherein trading with other collectors comprises
means for obtaining information from the system about what items the other collectors have and lack;
means for offering to trade items with them; and
means for enabling the other collectors to accept, reject or counter the offer.

33. A computer readable storage medium for storing program code for, when executed, causing a computer to perform a computerized method for collecting items comprising:
receiving collectible items on a system;
trading the items with other collectors, wherein trading with other collectors includes obtaining information from the system about what items the other collectors have and lack;
offering to trade with collectors, and enabling the other collectors to accept, reject or counter the offer; and
interacting with the items on the system.

34. The apparatus of claim 33 further comprising means for distributing collectible items to collectors.

35. A graphic interface for use with a system for collecting items comprising:
means for selecting a Zone;
means for viewing the collectible items of a Zone;
means for viewing the collectible items owned by other collectors; and
means for building an offer to trade collectible items with other collectors.
